(19) United States
(12) Patent Application Publication
(10) Pub. No.: US 2004/0118159 A1
(43) Pub. Date: Jun. 24, 2004

(54) Method of fabricating a hollow glass article including a stage of assisted stretching of the blank, and an installation for implementing the method

(76) Inventors: Max Rombouts, Margraten (NL); Chris Van Reijmersdal, Ea Berg En Terblijt (NL); Gerard Pajean, Charly (FR); Sisaveng Rattana, Villeurbanne (FR)

Correspondence Address: CLARK & BRODY, Suite 600, 1750 K Street, NW, Washington, DC, 20006, US

(21) Appl. No.: 10/673,166

(22) Filed: Sep. 30, 2003

(30) Foreign Application Priority Data
Oct. 4, 2002 (FR) 02 12 327

(51) Int. Cl. C03B 9/20; C03B 9/24

(52) U.S. Cl. 65/77; 65/81; 65/242; 65/300

(57) ABSTRACT

A method of fabricating at least one hollow glass article by implementing fabrication cycle consisting, specifically, in stretching the blank prior to inflating it by transferring the blank into a finishing mold that includes a suction cup in its mold cavity, the suction cup being movable in translation parallel to the axis of the mold over a stretching stroke between firstly an extended position inside the mold and secondly a retracted position in which the suction cup is situated at the bottom of the mold. The method includes the step of establishing suction in the suction cup prior to the bottom of the blank coming into contact therewith, thereby uniting the bottom of the blank with the suction cup while it is placed in its extended position, and then displacing the suction cup to its retracted position in order to stretch the blank.

The present invention relates to the technical field of fabricating hollow glass articles from a gob of molten glass that is subjected to various molding operations.

### BACKGROUND OF THE INVENTION

In general, a hollow glass article possessing an open section, such as a pot, a jar, or a bottle, for example, is produced by initially using a roughing mold to form a blank from a gob of molten glass, also known as a “parison”.

The blank is then transferred to a finishing mold in which the blank is subjected to elongation and is then inflated inside the finishing mold so as to obtain the hollow glass article, which is then extracted from the finishing mold.

That method of fabrication is generally performed as a continuous cycle on a given machine, such that the machine repeats those operations with a predetermined period.

Various techniques can be implemented for forming the blank, for example it can be blown within the rouging mold or it may be pressed by means of a punch engaged in the roughing mold.

Similarly, inflating the blank so as to obtain the hollow glass article can be a result either of injecting a gas under pressure into the blank, or of establishing suction in the finishing mold.

Whichever technique is used for forming the blank and for inflating it so as to obtain the hollow glass article, the blank can be stretched within the finishing mold either spontaneously as a result merely of gravity, with the blank stretching under the effect of its own weight, or else, on the contrary, it can be assisted mechanically by means of a puller device.

More particularly, the invention relates to the field of fabricating hollow glass articles in which the stretching of the blank is assisted.

Implementing such assisted stretching, e.g. as described in U.S. Pat. No. 4,276,073 or in French patent application No. FR 2,808,019, presents the advantage of shortening the total time required by the fabrication cycle. By shortening the cycle time in this way, assisted stretching also makes it possible to reduce the temperature of the gob of glass used, since with stretching that is assisted mechanically there is no need to ensure that the molten glass blank is sufficiently liquid to stretch spontaneously under the effect of its own weight.

Another advantage of the assisted-stretching technique lies in the possibility of using a lighter-weight gob of molten glass and of obtaining a hollow glass article of smaller wall thickness for equivalent mechanical qualities, since the glass is distributed more uniformly within the volume of the hollow article.

The techniques described in the above-cited documents do indeed enable such assisted stretching to be implemented so as to obtain a method that presents the above-mentioned advantages.

However, it has been found that the performance of prior art fabrication methods can be further improved so as to reduce cycle times and obtain hollow glass articles presenting better characteristics both mechanically and in terms of appearance.

In particular, it has been found that a substantial improvement to the fabrication method can be obtained by managing how the puller device takes charge of the non-stretched blank, both in terms of the instant it takes hold of it during the fabrication cycle, and in terms of the device that actually makes the connection between the puller system and the blank.

### OBJECTS AND SUMMARY OF THE INVENTION

Thus, in order to improve the assisted-pulling technique of fabricating hollow glass articles, the invention provides a method of fabricating at least one hollow glass article in a fabrication cycle consisting, in particular in:

forming a blank from a gob of molten glass within a roughing mold;

transferring the blank into a finishing mold having, in a mold cavity, a suction cup movable in translation parallel to the axis of the mold over a stretching stroke between firstly an extended position inside the mold and secondly a retracted position in which the suction cup is situated at the bottom of the mold;

establishing suction in the suction cup to unite the bottom of the blank with the suction cup placed in the extended position;

moving the suction cup to the retracted position to stretch the blank;

reestablishing atmospheric pressure at the suction cup;

inflating the stretched blank inside the finishing mold in order to obtain the hollow glass article;

opening the finishing mold; and

extracting the hollow glass article from the finishing mold.

According to the invention, this fabrication method further consisting in establishing suction in the suction cup prior to the bottom of the blank coming into contact with the suction cup.

It has been found that establishing suction in the suction cup before the bottom of the blank comes into contact therewith makes it possible to reduce the time needed for the blank to stabilize after transfer from the roughing mold to the finishing mold, thereby enabling the total duration of the fabrication cycle to be reduced. Establishing suction in the suction cup serves to force the blank to be placed on the axis of the mold of the molding cavity so that swinging of the blank is brought under control.

According to a characteristic of the invention, suction is established in the suction cup when the distance between the suction cup and the bottom of the blank is less than 10 millimeters (mm), and preferably lies in the range 1.5 mm to 2.5 mm.

According to another characteristic of the invention, suction is established in the suction cup after 83% to 90% of the fabrication cycle has elapsed, and preferably after 84.16% to 85.28% of the fabrication cycle has elapsed, the beginning of the fabrication cycle being considered as the moment when the roughing mold is closed and empty prior to a molten gob being inserted therein.

According to yet another characteristic of the invention, the suction cup is moved after suction has been established in said suction cup with a time offset of duration lying in the range 0.25% to 3.5% of the total duration of the fabrication cycle, and preferably with a time offset lying in the range 0.25% to 2% of the total duration of the fabrication cycle or of the period of said cycle if fabrication is performed continuously.

Furthermore, it has been found that the best improvement in performance of the fabrication method is ensured when the duration of the assisted-stretching stroke is less than half the time taken by the blank to reach the same degree of total stretching under the effect of its own weight.

In preferred, but not strictly necessary manner, the duration of the assisted-stretching stroke then lies in the range 13% to 18% of the total duration of the fabrication cycle, and in optimum manner in the range 10% to 15% of the total duration of the fabrication cycle.

According to another characteristic of the invention, the fabrication method is implemented by moving the suction cup at varying speed during the stage in which the blank is stretching. In preferred manner, the speed of the suction cup during the stretching stage is adjusted in such a manner as to vary so as to reach a maximum speed lying in the range 100 millimeters per second (mm/s) to 300 mm/s.

According to another characteristic of the invention, the level of the suction established in the suction cup is more negative than −0.4×10⁵ Pascals (Pa), and preferably lies in the range −0.8×10⁵ Pa to −0.5×10⁵ Pa.

Furthermore, it has been found that very good fabrication results are obtained when the molten gob of glass at the time of its insertion into the roughing mold is at a temperature lying in the range 1100° C. to 1200° C.

Similarly, it has been found that the quality of the glass article that is produced can be optimized by controlling the temperature of the suction cup with which the blank comes into contact during the stretching stage. Thus, according to a characteristic of the invention, in order to avoid the suction cup rising excessively in temperature, and after the glass article has been extracted from the finishing mold, the fabrication method further consists in injecting a cooling fluid into the suction cup. Thus, a high-quality article is obtained when the suction cup is maintained at a temperature below 500° C., and preferably at a temperature lying in the range 400° C. to 500° C.

According to a characteristic of the invention, in order to cool the suction cup in this way, the fluid used is compressed air delivered at a pressure lying in the range 3.3×10⁵ Pa to 7×10⁵ Pa, and presenting a temperature lying in the range 20° C. to 50° C.

It has also been found possible to optimize the taking hold of the blank in the finishing mold by the puller suction cup by forming the blank in such a manner that on being inserted into the finishing mold it presents a bottom end that is concave. Best results are then obtained when the blank is formed so that the maximum depth of its concave bottom end lies in the range 1 mm to 30 mm, and preferably in the range 1 mm to 5 mm.

Similarly, it has been found that the best results are obtained when the blank presents a height lying in the range 30% to 75% of the height of the finishing mold.

According to the invention, the blank can be inflated either by establishing suction in the finishing mold or by blowing gas into the blank, for example by blowing in compressed air.

According to the invention, the method of fabrication can be implemented so as to fabricate n identical hollow glass articles simultaneously. The method of the invention then consists, specifically, in:

forming n blanks in n roughing molds;

simultaneously transferring the n blanks into n finishing molds, each including in its mold cavity a puller suction cup movable in translation parallel to the axis of the mold over a stretching stroke between firstly an extended position inside the mold cavity and secondly a retracted position in which the suction cup is situated at the bottom of the mold cavity;

simultaneously establishing suction at the n suction cups;

simultaneously displacing the n suction cups to the retracted position;

simultaneously reestablishing atmospheric pressure in the n suction cups;

simultaneously inflating the n stretched blanks;

simultaneously opening the n finishing molds; and

simultaneously extracting the n hollow articles from the n finishing molds.

Depending on the technique used for transferring the blanks from the roughing mold to the finishing mold, the blanks can present different confirmations on reaching the finishing molds. In order to take account of these differences, the fabrication method of the invention consists in adopting strokes of different lengths for the suction cups in different molds.

Thus, when implementing blank transfer by means of a rocker mechanism which extracts blanks from the roughing molds and engages them the other way up in the finishing molds by turning through 180° about a horizontal axis, the method of the invention consists in giving the suction cups stretching strokes that decrease with increasing distance of the finishing molds from the pivot axis of the rocker mechanism. The further the blanks are from the pivot axis of the rocker mechanism, the more they are subjected to centrifugal force which contributes to increasing their stretching on being introduced into the finishing molds and while the transfer mechanism is turning.

The invention also provides an installation for fabricating at least one hollow glass article, the installation comprising at least one molding assembly that comprises:

a roughing mold comprising two roughing half-bodies and a roughing bottom together defining a roughing cavity;

a finishing mold comprising firstly two finishing half-bodies and a finishing bottom together defining a molding cavity and secondly assisted-stretching means comprising:

a suction cup carried by a member movable in translation along the mold axis in order to displace the suction cup between an extended position inside the mold and a retracted position in which the suction cup is situated at the bottom of the mold;

drive means for moving the moving member; and

a pneumatic circuit connected to the suction cup;

a ring element and transfer means for transferring the ring element alternately between the roughing mold and the finishing mold.

According to the invention, in the installation:

the suction cup presents a central suction surface connected to the pneumatic circuit and a peripheral surface that is impervious to air; and

the suction surface of the suction cup presents a maximum diameter Dₘₐₓ substantially equal to the mean diameter Dₘₑₐₙ of the blank to be stretched.

This characteristic of the invention provides good control over the stresses exerted by the suction cup on the blank while it is taking hold of the blank, and also while it is stretching it, thus ensuring that the glass article fabricated by means of the installation of the invention does not suffer from defects of appearance or structure.

According to a characteristic of the invention, the roughing mold has a punch, and the mean diameter Dₘₐₓ of the blank satisfies the following relationship:

$$\frac{π}{4} ( {D}_{max} ) {}^{2} hp = \frac{Ve + Vp}{2}$$

where:

hp is the height of the blank (36) beyond the ring;

Ve is the volume of the roughing cavity (4); and

Vp is the volume of the imprint (41) made by the punch (5) beyond the ring.

According to the invention, the suction surface of the suction cup can be made in any appropriate manner. According to a characteristic of the invention, the suction surface of the suction cup is constituted by a porous material, such as sintered metal or indeed ceramic, by way of non-exclusive examples.

According to another characteristic of the invention, the suction surface of the suction cup is made of a metal presenting good thermal conduction characteristics, and has knurling on its surface together with a peripheral collector groove connected to the pneumatic circuit.

Setting the suction cup into operation presents the advantage of ensuring that intimate contact is established between the suction cup and the blank, thus making it possible to ensure that relatively fine decorative elements can be molded on the bottom of the hollow glass article, including writing information by means of signs and symbols that are likewise relatively fine.

According to a characteristic of the invention, in order to enable the suction cup to be cooled effectively, it presents internal cooling fins which extend in a duct connecting the suction cup to the pneumatic circuit.

According to another characteristic of the invention, the suction cup is integrated in the bottom of the finishing mold which is movable in translation so as to form the member that moves in translation for stretching the blank.

According to another characteristic of the invention, in order to enable the stretching suction cup to take hold of the blank effectively, the bottom of the roughing mold is convex so that when the blank is put into place in the finishing mold its bottom is concave. In preferred manner, the convex portion of the roughing mold projects by an amount lying in the range 1 mm to 30 mm.

The invention also provides a hollow glass article obtained by means of the method of the invention.

### BRIEF DESCRIPTION OF THE DRAWINGS

Various other characteristics appear from the following description made with reference to the accompanying drawings which show embodiments of the invention as non-limiting examples.

FIG. 1 is a diagrammatic longitudinal section view of a roughing mold forming part of a fabrication installation for implementing the method of the invention.

FIG. 2 is a diagrammatic longitudinal section of a finishing mold constituting part of an installation for implementing the fabrication method of the invention.

FIGS. 3 to 10 are diagrammatic views of an installation for fabricating three hollow glass articles simultaneously in accordance with the invention, showing different stages in the implementation of the method.

FIG. 11 is a diagrammatic section view on a larger scale showing the distance that exists between the bottom of a blank and the suction surface of a suction cup at the moment suction is established in the suction cup in accordance with the method of the invention.

FIG. 12 is a plan view of a suction cup in accordance with the invention.

FIG. 13 is a fragmentary diagrammatic section view of a blank, substantially analogous to FIG. 2, showing the relationship that exists between the suction surface of the suction cup and the dimensions of the blank.

FIG. 14 is a view substantially analogous to FIG. 2, showing a finishing mold in which a blank is placed.

FIG. 15 is a view substantially analogous to FIG. 13 showing a finishing mold for forming a hollow glass article, such as a jam jar.

FIG. 16 is a longitudinal section view of a blank in accordance with the invention prior to stretching.

FIGS. 17 and 18 are longitudinal section views of a puller suction cup of the invention.

FIGS. 19 and 20 are plan views of suction cups in accordance with the invention.

FIGS. 21 and 22 are longitudinal section views analogous to FIGS. 17 and 18 showing other embodiments of a puller suction cup of the invention.

FIG. 23 is a longitudinal section view of a finishing mold for an installation for implementing the method of the invention, with the bottom of the mold being movable in translation and having a puller suction cup integrated therein for implementing the fabrication method of the invention.

### MORE DETAILED DESCRIPTION

The invention provides improvements to methods of fabricating hollow glass articles using a cycle of fabricating an article from a glass gob which is subjected to various successive operations serving firstly to obtain a blank, and then from said blank to obtain the finished hollow glass article by an “inflation” operation.

This fabrication method thus enables hollow glass articles such as wine or beer bottles or any other article to be obtained, e.g. pots for food, such as yogurt pots or jam jars.

The installation for implementing the method is generally designed to enable one or more articles to be fabricated simultaneously. To this end, the installation comprises one or more molding units depending on the number of articles to be fabricated simultaneously.

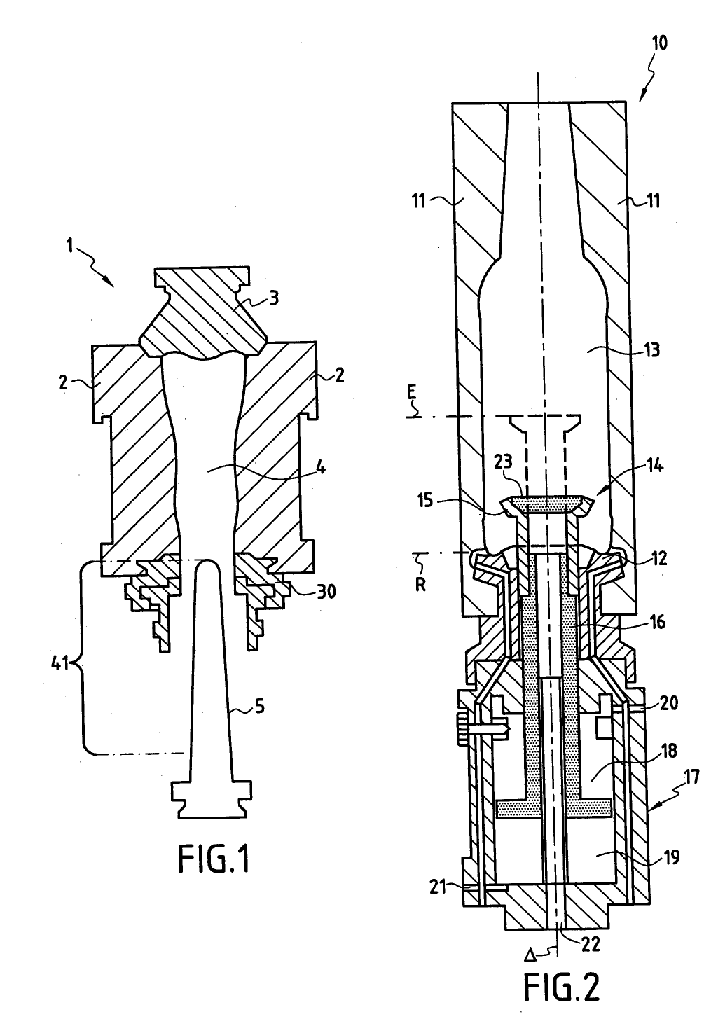

Each molding unit then comprises at least one roughing mold as shown in FIG. 1 given overall reference 1. In general manner, the roughing mold comprises two roughing half-bodies 2 and a roughing bottom 3, which together define a roughing cavity 4. In the example shown, the roughing mold 1 further comprises a piercing punch 5 for insertion into the roughing cavity 4, as described below.

In addition to the roughing mold 1, each molding unit further comprises a finishing mold as shown in FIG. 2 and given overall reference 10.

In general manner, the finishing mold 10 comprises two finishing half-bodies 11 and a finishing bottom 12 which together define a mold cavity 13. In order to be able to stretch the blank mechanically, and in accordance with an essential characteristic of the invention as described below, the finishing mold 10 includes assisted-stretching means 14 which comprise a suction cup 15 carried by a member 16, such as, for example, a rod that is movable in translation along the axis Δ of the mold between an extended position E shown in chain-dotted lines in FIG. 2 and a retracted position R, also shown in chain-dotted lines. In the retracted position R, the suction cup 15 is situated at the bottom 12 of the mold and is substantially set into the bottom of the mold.

In order to move the moving member 16, the assisted-stretching means 14 comprise drive means 17 that can be implemented in any suitable manner and that are formed in the example shown by a double-acting pneumatic actuator. The two chambers 18 and 19 of the actuator 17 are then connected by lines 20 and 21 to a pneumatic control system (not shown). The assisted-stretching means also comprise a pneumatic circuit 22 connected to the suction cup 15. In accordance with an essential characteristic of the invention, the suction cup 15 then presents a central suction surface 23 which is connected to the pneumatic circuit 22.

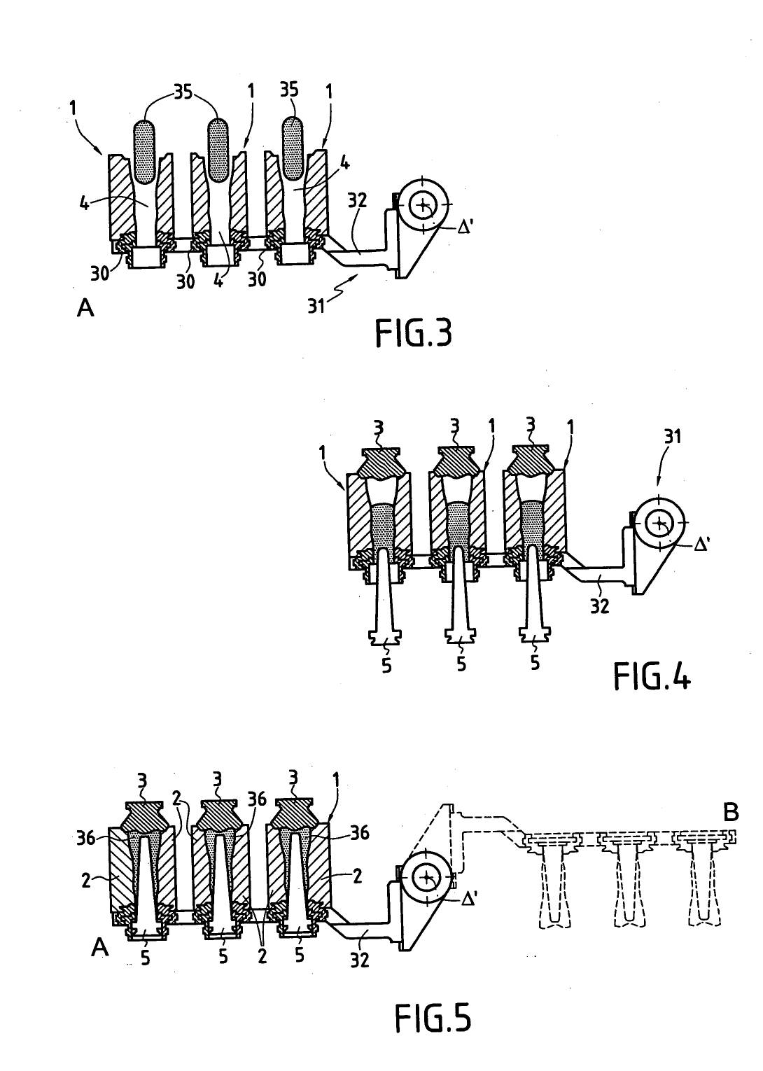

The molding unit also comprises a ring element 30 and transfer means 31 shown diagrammatically in FIG. 3. The transfer means 31 are then adapted to enable the ring element 30 to move in alternation between the roughing mold 1 and the finishing mold 10, as described below.

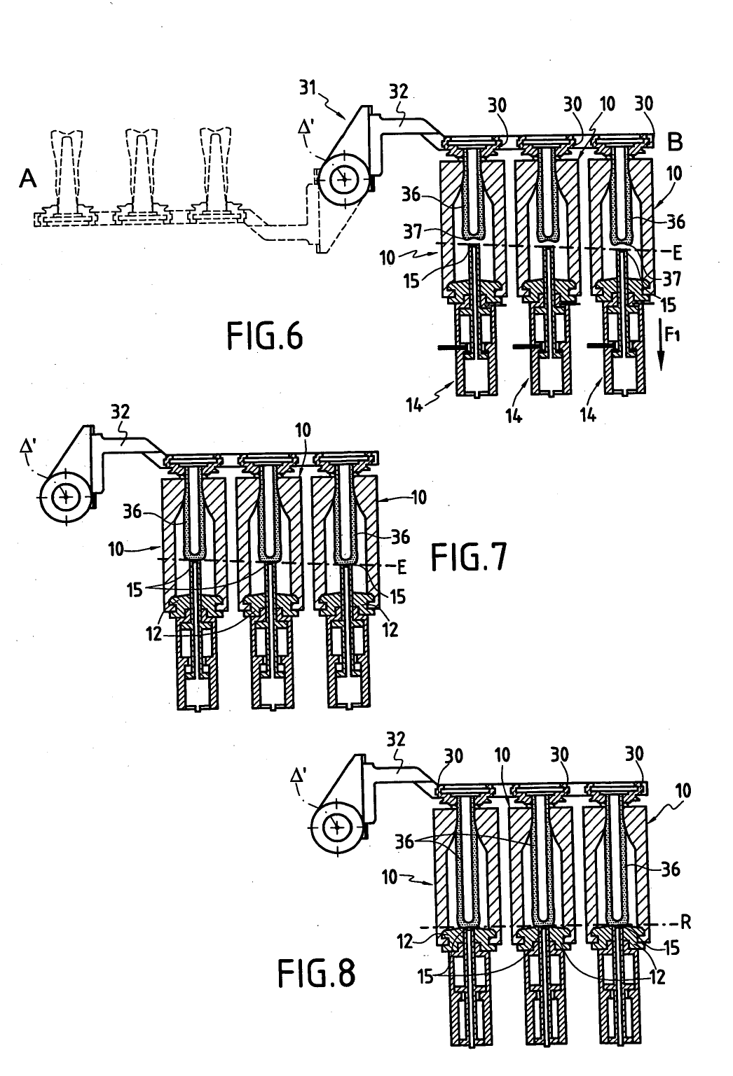

In the example shown in FIGS. 3 to 10, the installation of the invention is adapted to fabricate three hollow glass articles simultaneously, so that it comprises three distinct molding units. In this example, the transfer means 31 comprise a rocker arm 32 carrying the three ring elements 30 of the molding unit. The rocker arm 32 is then movable in rotation about a substantially horizontal axis Δ′ between a position A as shown in FIG. 3 in which the ring elements 30 are placed in register with corresponding roughing molds 1, and a position B shown more particularly in FIG. 6 in which the ring elements 30 are placed in register with corresponding finishing molds 10. It should be observed that the ring elements are turned upside-down on the rocker arm 30 going from position A and to position B, and vice versa.

Hollow glass articles are fabricated by means of the above-described installation as follows.

At the beginning of the fabrication cycle, a gob of molten glass 35 is supplied by a feeder mechanism (not shown) to each of the three roughing molds 1. Each gob of glass 35 is then engaged in the mold cavity 4 through the open bottom of the corresponding roughing mold 1. In preferred but not strictly necessary manner, the gob of glass is supplied to the roughing molds at a temperature lying in the range 1100° C. to 1200° C.

After this first “feeding” step, there follows a “pressing” step shown in FIGS. 4 and 5 during which the bottoms of the molds 3 are put into place to close the roughing molds 1, while the piercing punches 5 of the roughing molds 1 are inserted into the corresponding molds so as to penetrate into the glass gobs 35 which are subjected to a “piercing” operation having a first stage shown in FIG. 4, which operation terminates by the punches 5 being fully inserted into the molds, thereby shaping blanks 36 in the respective roughing molds 1 by means of the mechanical stress exerted by the punches 5 shaping the glass gobs 35 inside the mold cavities 4.

At the end of this pressing operation, the roughing molds 1 are opened by removing the bottoms 3, opening the roughing half-bodies 2, and withdrawing the punches 5, so that the blanks 36 are released from the roughing molds 1 while remaining secured to the corresponding ring elements 30.

At this stage of fabrication, there follows a blank transfer stage 36 in which the rocker arm 32 passes from position A to position B, as shown in FIG. 5, in such a manner that the blanks 36 are ready to be enclosed in the molding cavities 13 of the three corresponding finishing molds 10, as shown in FIG. 6.

In this position, inside the finishing molds 10, the blanks 36 of molten glass have a natural tendency to stretch under the effect of their own weight in the direction of arrow F₁. However, in order to accelerate this “stretching” stage, and thus shorten the total duration of the fabrication cycle of a glass article, the finishing molds 10 are fitted with assisted-stretching means 14.

After being turned upside-down, the blanks tend to swing and stretching cannot take place until they lie substantially on the axes Δ of the finishing molds 10. However, in order to accelerate stabilization of the blank 36 and in accordance with an essential characteristic of the invention, suction is established at the suction cups 15 in each of the molds even before the bottoms 37 of the blanks 36 have come into contact with the corresponding suction cups 15, as shown in FIG. 6.

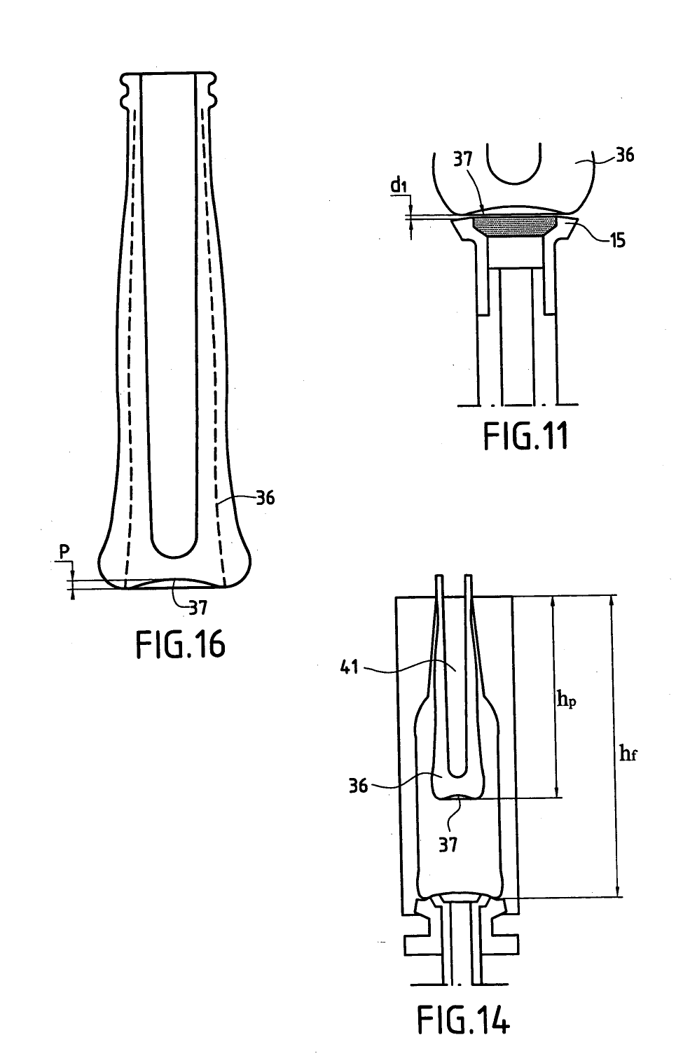

In preferred manner and, as shown in the detail of FIG. 11, suction is established in each of the suction cups 15 when the distance d₁ between the bottom of the blank 36 and the suction cup 15 is less than 10 mm, and preferably lies in the range 1.5 mm to 2.5 mm.

Suction can thus be established in the suction cups 15 after 83% to 90% of the cycle for fabricating a hollow glass article has elapsed, with the beginning of the cycle corresponding to issuing the instruction to close the roughing molds. Preferably, suction is established in the suction cups 15 after 84.16% to 85.28% of the fabrication cycle has elapsed.

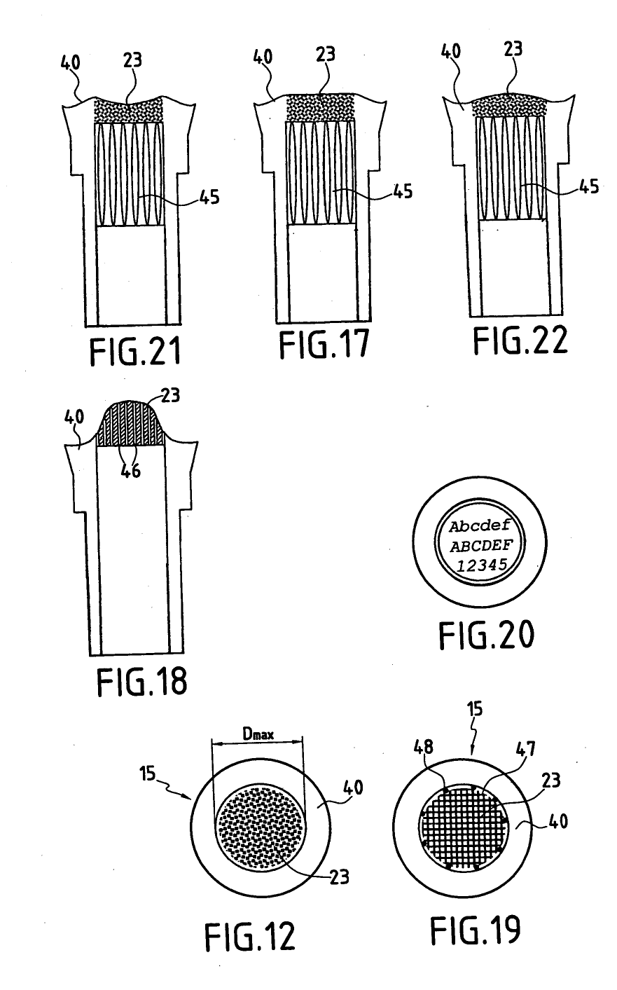

In accordance with an essential characteristic of the invention, in order to ensure that establishing suction in the suction cup 15 and then engaging the stage of assisted stretching does not lead to the blank being subjected to stresses liable to spoil the appearance or even the structure thereof by weakening the hollow glass article obtained at the end of fabrication, each suction cup 15 is made in such a manner that its suction surface 23 occupies a central region of the suction cup 15 and is surrounded by a peripheral surface 40 that is substantially impervious to air, and in the example shown, smooth, as can be seen in the plan view of FIG. 12.

In addition, the suction surface 23 is shaped in such a manner as to present a maximum diameter Dₘₐₓ substantially equal to the mean diameter Dₘₑₐₙ of the blank 36 that is to be stretched, as can be seen in FIG. 13. This mean diameter Dₘₑₐₙ is equal to the mean diameter of the neutral fiber which corresponds to the set of diameters that define a transverse surface subdividing the blank 36 into two equal volumes.

According to a characteristic of the invention and in order to make calculation easier, the mean diameter Dₘₑₐₙ is defined as being the diameter of the cylinder whose side surface subdivides the blank 36 into two equal volumes. Thus, the diameter Dₘₑₐₙ satisfies the following equation:

$$\frac{π}{4} ( {D}_{max} ) {}^{2} hp = \frac{Ve + Vp}{2}$$

where:

hp is the height of the blank outside the ring, as shown in FIG. 14 and prior to the blank beginning to be stretched;

Ve is the volume of the cavity 4 of the roughing mold; and

Vp is the volume of the imprint 41 made therein by the punch 5 beyond the ring.

As shown in comparison in FIGS. 13 and 15, depending on the type of hollow glass article being fabricated, the mean diameter Dₘₑₐₙ, and thus the maximum diameter of the suction surface, can be greater than or less than the diameter of the mouth of the hollow glass article that is being fabricated. Thus, when fabricating a bottle, as shown in FIG. 13, the diameter Dₘₐₓ of the suction surface 23 is greater than the diameter of the mouth of said bottle, whereas when fabricating a pot, as shown in FIG. 15, the diameter Dₘₐₓ of the suction surface 23 is less than the diameter of the mouth of said pot.

Furthermore, according to a preferred but not strictly necessary characteristic of the invention, in order to enhance the effect of suction between the bottom 37 of the blank 36 and the suction cup 15, the bottom 37 of the blank 36 is concave.

For this purpose, the bottom 3 of the roughing mold 1 is convex in shape as can be seen more particularly in FIG. 1. In preferred but not strictly necessary manner, the maximum depth P, shown in FIG. 16, of the concave portion of the bottom 37 of the blank 36 lies in the range 1 mm to 30 mm, and preferably in the range 1 mm to 5 mm. The suction which is established in the suction cup 15 is preferably, but not exclusively, more negative than −0.4×10⁵ Pa, and preferably lies in the range −0.8×10⁵ Pa to −0.5×10⁵ Pa.

When the bottom 14 of the blank 36 facing the suction surface 23 has come completely into direct contact with the suction cup 15, as shown in FIG. 7, the drive means 17 are set into motion to move the suction cups 15 over a stretching stroke away from their position of maximum extension E.

In the example shown, in order to take account of the different lengths of the blanks 36 on being inserted into the finishing molds 10 due to the different centrifugal forces to which they are subjected while being turned over by the rocker arm, it should be observed that the stretching strokes of the suction cups decrease with increasing distance of the finishing molds from the pivot axis Δ′ of the rocker arm 32 of the transfer means 31. Thus, as can be seen more particularly in FIG. 6, the maximum extension height of the suction cup in the mold situated closest to the axis Δ′ is greater than the extension heights E of the molds that are situated further away from the axis Δ′, as can be seen more particularly in FIG. 6.

In addition, the length of each stretching stroke is a function of the height of the blank 36 or its profile height hp as measured excluding the height of the ring and relative to the height hf of the cavity in the finishing mold, again excluding the ring components, as can be seen in FIG. 15. In the invention, the profile height hp of the blank preferably lies in the range 30% to 75% of the height hf of the finishing mold.

In preferred manner, in the invention, the suction cups 15 are moved after suction has been established in said suction cups 15, with a time offset of duration lying in the range 0.25% to 3.5%, and preferably in the range 0.25% to 2% of the total duration of the fabrication cycle. The suction cups 15 are then preferably caused to move downwards in such a manner that the duration of the assisted-stretching stroke is less than half the time that the blank would have taken to achieve the same degree of stretching under the effect of its own weight, so as to obtain a sufficient improvement in productivity.

Thus, the duration of the assisted-stretching stroke preferably lies in the range 10% to 15% of the total duration of the fabrication cycle, and for this purpose the displacement means 17 are controlled so as to cause the speed of displacement of the suction cups during the stretching stroke to vary, and in particular preferably so as to obtain a maximum speed lying in the range 100 mm/s to 300 mm/s.

Such speed values thus make it possible to achieve a substantial improvement in productivity while not leading to stresses in the blank that might give rise to defects in appearance or structure. Thus, during the stretching stroke, the suction cups 15 pass from their maximum extension position E, as shown in FIG. 7 to their retracted position R, as shown in FIG. 8, in which the suction cups 15 are engaged in the bottoms 12 of the finishing mold 10 and the blanks 36 are stretched to the full height of the mold cavities.

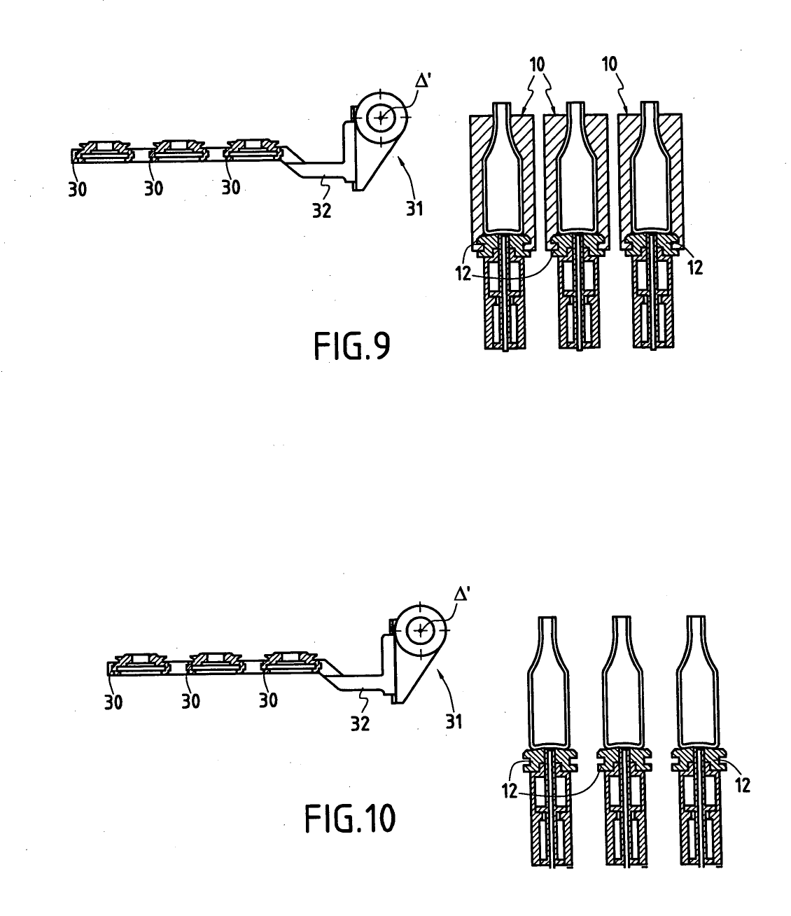

After this assisted-stretching stage there follows inflation of the blanks which, in the example shown, is performed by establishing suction within the cavities of the finishing molds 10 in their volumes that lie between the blanks 36 and the walls of the corresponding finishing molds 10. This inflation serves to press the walls of the blanks 36 against the walls of the finishing molds 10, as shown in FIG. 9, in such a manner as to impart their final shape to the blanks 36, corresponding to the hollow glass articles that are being made.

After this inflation step, the finishing molds 10 are opened, as shown in FIG. 10. A new fabrication cycle can then begin, with the fabricated hollow articles being taken away by gripper devices (not shown). It should be observed that in the example shown, the rocker arm 32 returns to its initial position A only at the end of the assisted-stretching stage. However, this return of the rocker arm to its position A could take place earlier.

Furthermore, after the finished hollow glass articles have been withdrawn, compressed air is preferably blown into the suction cups in order to cool them. It has been found that it is preferable to maintain the temperature of the suction cups at below 500° C., and preferably at a temperature in the range 400° C. to 500° C. so as to avoid forming defects in the bottoms of the fabricated hollow glass articles. In order to provide this cooling, compressed air is injected at a pressure lying in the range 3×10⁵ Pa to 7×10⁵ Pa, with the air preferably at a temperature lying-in the range 20° C. to 50° C.

According to a characteristic of the invention, in order to optimize cooling of the suction cups 15, their channels connecting them to the pneumatic circuit 22 preferably include fins or fluting 45 as shown in FIG. 17. The fins 45 then act as radiators by increasing the heat exchange areas of the suction cups with the compressed air flowing in the channels.

In accordance with the invention, the suction surfaces of the suction cups 15 may be made in any suitable manner.

In the example shown in FIGS. 12 and 17, the material constituting the suction surface 23 is a porous material such as, for example, sintered metal or indeed a ceramic. Naturally, the suction surfaces of the suction cups 15 could be made in any other manner. Thus, FIG. 18 shows the suction surface of a suction cup made out of a solid metal presenting a series of bores 46 distributed over its surface.

In another embodiment, shown in FIG. 19, the suction surface 23 is made in the form of a knurled metal block. At its periphery, the knurled surface then presents a collector groove 47 connected via through bores 48 to the suction circuit. Various knurling conformations can be used.

Furthermore, given the suction established at the suction surface 23 which guarantees intimate contact between the bottom of the shaped blank 37 and the suction cup 15, it is possible to mark the bottom of the resulting glass article with relatively simple patterns. Thus, FIG. 20 shows an embodiment of the suction surface of the suction cup in which the suction surface presents alphanumeric patterns. Naturally, any other kind of decorative pattern, for example trademark logos or geometrical drawings could also be envisaged.

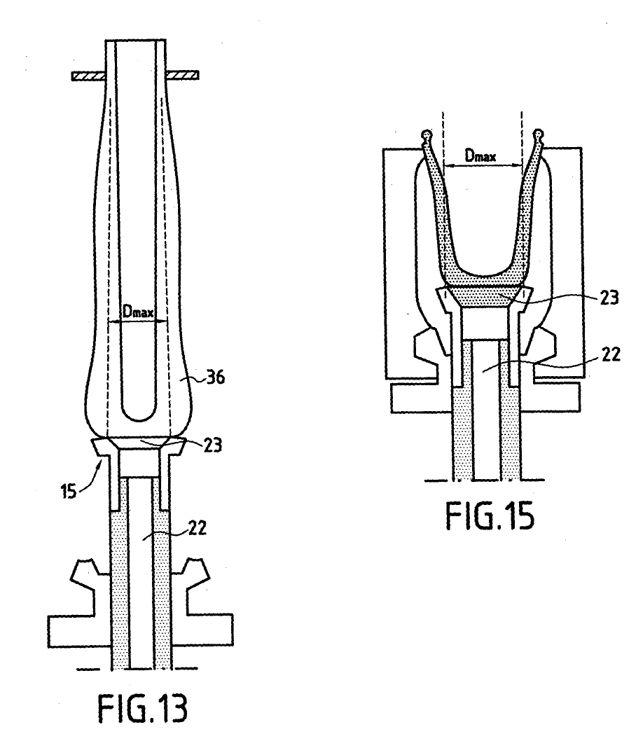

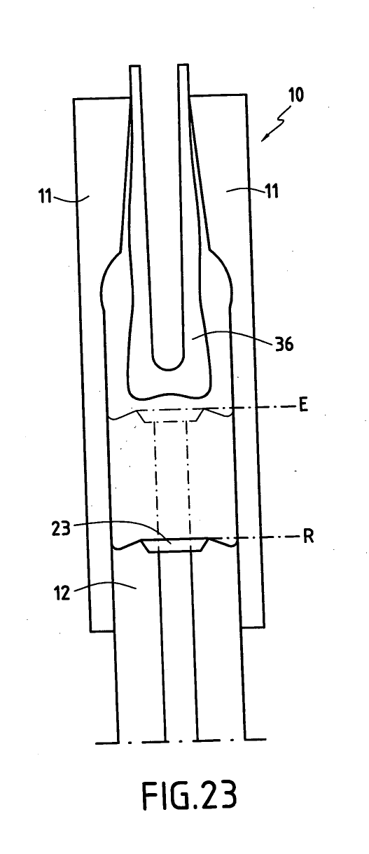

Similarly, in the examples shown in FIGS. 1 to 17, the suction surfaces 23 are plane in profile. Nevertheless, in the invention, the profile of the suction surfaces 23 could equally be concave as shown in FIG. 21 or convex as shown in FIGS. 18 and 22. It should be observed that in the example of FIG. 18, the suction cup does not have any internal fins.

Furthermore, in the examples shown above, the suction cup 15 of the finishing mold 10 for mechanically stretching the blank is itself movable relative to the bottom 12 of the finishing mold 10. Nevertheless, in accordance with the invention, this configuration is not strictly necessary. Thus, FIG. 23 shows the case of the suction cup 15 being integrated in the bottom 12, with the bottom itself then being movable as a whole between the extended position E and the retracted position R for the purpose of mechanically stretching the blank 36.

Naturally, various other modifications could be applied to the method and the installation for fabricating hollow glass articles as described above without going beyond the ambit of the present invention.

What is claimed is:

1. A method of fabricating at least one hollow glass article using a fabrication cycle consisting in particular in:
forming a blank from a gob of molten glass within a roughing mold;
transferring the blank into a finishing mold having, in a mold cavity, a suction cup movable in translation parallel to the axis of the mold over a stretching stroke between firstly an extended position inside the mold and secondly a retracted position in which the suction cup is situated at the bottom of the mold;
establishing suction in the suction cup to unite the bottom of the blank with the suction cup placed in the extended position;
moving the suction cup to the retracted position to stretch the blank;
reestablishing atmospheric pressure at the suction cup;
inflating the stretched blank inside the finishing mold in order to obtain the hollow glass article;
opening the finishing mold; and
extracting the hollow glass article from the finishing mold;
the method consisting in establishing suction in the suction cup prior to the bottom of the blank coming into contact with the suction cup.

2. A method according to claim 1, consisting in establishing suction in the suction cup when the distance between the suction cup and the bottom of the blank is less than 10 mm, and preferably lies in the range 1.5 mm to 2.5 mm.

3. A method of fabrication according to claim 1, consisting in establishing suction in the suction cup after 83% to 90% of the fabrication cycle has elapsed.

4. A method of fabrication according to claim 1, wherein the suction cup is moved after suction has been established in the suction cup with a time offset of duration lying in the range 0.25% to 2% of the total duration of the fabrication cycle.

5. A method according to claim 1, wherein the duration of the assisted-stretching stroke is less than half the time that would be taken by the blank to reach the same degree of stretching under the effect of its own weight.

6. A method according to claim 1, wherein the duration of the assisted-stretching stroke lies in the range 10% to 15% of the total duration of the fabrication cycle.

7. A method according to claim 1, consisting in moving the suction cup during the stage of stretching the blank by causing its speed to vary as it moves.

8. A method according to claim 7, consisting in causing the displacement speed of the suction cup to vary so as to reach a maximum speed lying in the range 100 mm/s to 300 mm/s.

9. A method according to claim 1, wherein the level of the suction established in the suction cup is more negative than −0.4×10⁵ Pa, and preferably lies in the range −0.8×10⁵ Pa to −0.5×10⁵ Pa.

10. A method according to claim 1, wherein the gob of molten glass is at a temperature lying in the range 1100° C. to 1200° C.

11. A method according to claim 1, consisting, after the glass article has been extracted, in injecting a cooling fluid into the suction cup.

12. A method according to claim 11, consisting in maintaining the suction cup at a temperature lower than 500° C., and preferably lying in the range 400° C. to 500° C.

13. A method according to claim 12, wherein the cooling fluid is compressed air at a pressure lying in the range 3.3×10⁵ Pa and 7×10⁵ Pa, presenting a temperature lying in the range 20° C. to 50° C.

14. A method according to claim 1, consisting in forming the blank in such a manner that on being inserted into the finishing mold the bottom of the blank is concave.

15. A method according to claim 14, consisting in forming the blank in such a manner that the maximum depth of its concave bottom lies in the range 1 mm to 30 mm, and preferably in the range 1 mm to 5 mm.

16. A method according to claim 1, consisting in forming the blank in such a manner that it presents a height lying in the range 30% to 75% of the height of the finishing mold.

17. A method according to claim 1, wherein the blank is inflated by establishing suction in the finishing mold.

18. A method according to claim 1, wherein the blank is inflated by blowing gas into the blank.

19. A method of fabrication according to claim 1, consisting, in order to fabricate a series of n identical hollow glass articles simultaneously, specifically in:
forming n blanks in n roughing molds;
simultaneously transferring the n blanks into n finishing molds, each including in its mold cavity a puller suction cup movable in translation parallel to the axis of the mold over a stretching stroke between firstly an extended position inside the mold cavity and secondly a retracted position in which the suction cup is situated at the bottom of the mold cavity;
simultaneously establishing suction at the n suction cups;
simultaneously displacing the n suction cups to the retracted position;
simultaneously reestablishing atmospheric pressure in the n suction cups;
simultaneously inflating the n stretched blanks;
simultaneously opening the n finishing molds; and
simultaneously extracting the n hollow articles from the n finishing molds.

20. A method of fabrication according to claim 19, consisting, for the suction cups of the n molds, in adopting strokes of different lengths.

21. A method of fabrication according to claim 20, consisting in:
for transferring the n blanks from the roughing modes to the finishing molds using a rocker mechanism for extracting the blank from the roughing modes and engaging them with opposite orientation into the finishing molds by turning through 180° about an axis; and
adopting stretching strokes for the suction cups that decrease with increasing distance of the finishing molds from the pivot axis of the rocker mechanism.

22. An installation for fabricating at least one hollow glass article, the installation comprising in particular at least one molding unit comprising:
a roughing mold comprising two roughing half-bodies and a roughing bottom together defining a roughing cavity;
a finishing mold comprising firstly two finishing half-bodies and a finishing bottom together defining a molding cavity and secondly assisted-stretching means comprising:
a suction cup carried by a member movable in translation along the mold axis in order to displace the suction cup between an extended position inside the mold and a retracted position in which the suction cup is situated at the bottom of the mold;
drive means for moving the moving member; and
a pneumatic circuit connected to the suction cup;
a ring element and transfer means for transferring the ring element alternately between the roughing mold and the finishing mold;
wherein:
the suction cup presents a central suction surface connected to the pneumatic circuit and a peripheral surface that is impervious to air; and
the suction surface of the suction cup presents a maximum diameter Dₘₐₓ substantially equal to the mean diameter Dₘₑₐₙ of the blank to be stretched.

23. An installation according to claim 22, wherein the roughing mold includes a punch and wherein the maximum diameter Dₘₐₓ of the suction cup satisfies the following relationship:
$$\frac{π}{4} ( {D}_{max} ) {}^{2} hp = \frac{Ve + Vp}{2}$$
where:
hp is the height of the blank beyond the ring;
Ve is the volume of the roughing cavity; and
Vp is the volume of the imprint made by the punch beyond the ring.

24. An installation according to claim 22, wherein the suction surface of the suction cup is constituted by a porous material.

25. An installation according to claim 24, wherein the suction surface of the suction cup is constituted by sintered metal.

26. An installation according to claim 24, wherein the suction surface of the suction cup is constituted by a ceramic.

27. An installation according to claim 22, wherein the suction surface of the suction cup presents knurling and includes an annular peripheral collector groove connected to the pneumatic circuit.

28. An installation according to claim 22, wherein the suction surface of the suction cup presents a portion in relief or an imprint for forming a pattern on the bottom of the hollow glass article.

29. An installation according to claim 22, wherein the suction cup presents cooling fins extending into a duct connecting the suction cup to the pneumatic circuit.

30. An installation according to claim 22, wherein the suction cup is integrated in the bottom of the finishing mold which thus constitutes the member that is movable in translation for stretching the blank.

31. An installation according to claim 22, wherein the bottom of the roughing mold is convex.

32. An installation according to claim 31, wherein the depth of the convex shape of the bottom of the roughing mold lies in the range 1 mm to 30 mm.

33. A hollow glass article obtained by implementing the method according to claim 1.
